(19) United States
(12) Patent Application Publication
(10) Pub. No.: US 2026/0230793 A1
(43) Pub. Date: Aug. 6, 2026

(54) HANDLING MULTIPLE UNIVERSAL SUBSCRIBER MODULE (MUSIM) BAND CONFLICT FOR UE IN TELECOMMUNICATION NETWORK

(71) Applicant: Samsung Electronics Co., Ltd., Suwon-si, Gyeonggi-do (KR)

(72) Inventors: Vinay Kumar SHRIVASTAVA, Bangalore (IN); Aby Kanneath ABRAHAM, Bangalore (IN); Sriganesh RAJENDRAN, Bangalore (IN)

(21) Appl. No.: 19/149,342

(22) PCT Filed: Feb. 14, 2024
(86) PCT No.: PCT/KR2024/095115

§ 371 Date: Jul. 18, 2025

(30) Foreign Application Priority Data
Feb. 14, 2023 (IN) 202341009782
Jan. 30, 2024 (IN) 2023 41009782

(51) Int. Cl. H04W 8/18; H04W 8/22; H04W 76/20

(52) U.S. Cl. CPC H04W 8/183; H04W 8/22; H04W 76/20

(57) ABSTRACT

The disclosure relates to a 5G or 6G communication system for supporting a higher data transmission rate. Embodiments herein provide to handle multiple universal subscriber module (MUSIM) band conflict for UE in telecommunication network. The method includes determining, by User Equipment (UE) (101), occurrence of band conflict or removal of a band conflict for MUSIM operation between first network (107) and second network (109) associated with UE. Further, selecting first network or second network for transmission of MUSIM assistance information based on network characteristics. Thereafter, transmitting signalling message to selected network to indicate occurrence of band conflict or removal of band conflict. Furthermore, receiving RRC Reconfiguration message from network apparatus. The RRC reconfiguration message comprises setup or removal or modification for band list or band combinations list that resolves band conflict or removes band conflict. Further, performing, transmission or reception operation with first network and second network simultaneously without encountering band conflict between first network and second network.

### TECHNICAL FIELD

The proposed embodiments relate to 5th Generation (5G) wireless communication. More particularly present disclosure relates to handling multiple universal subscriber module (MUSIM) band conflict for UE in telecommunication network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The principal object of the embodiments herein is to provide a handle MUSIM band conflict for UE in telecommunication network.

Another object of the invention is to enhance the performance of a User Equipment by avoiding the interference between the two connections.

Another object of the invention is to achieve an efficient coordination between the UE and the network apparatus to eliminate the band conflict.

### Solution to Problem

In one aspect, the objectives are achieved by providing a method for handling a Multiple Universal Subscriber Identity Module (MUSIM) band conflict by a UE in a telecommunication network. The method includes determining, by a User Equipment (UE), an occurrence of a band conflict or removal of a band conflict for MUSIM operation between a first network and a second network associated with the UE. Further, the method includes selecting, by the UE, a first network or a second network for the transmission of a MUSIM assistance information based on network characteristics. The network characteristics comprise at least one of capability to support 5G New Radio (NR), capablility to support carrier aggregation, or dual connectivity, being determined as a victim network for the band conflict, and being a network impacted due to the band conflict. Thereafter, the method includes transmitting, by the UE, a signalling message to the selected network to indicate the occurrence of the band conflict or removal of the band conflict. The signalling message comprises at least one of a UE assistance information message, UE capability message, RRC resume request message, RRC resume complete message, RRC connection request message and a RRC setup complete message. Furthermore, the method includes receiving, by the UE, a RRC reconfiguration message from the network apparatus. The RRC reconfiguration message comprises a setup or removal or modification for a band list or a band combination list that resolves the band conflict or removes the band conflict. Further, the method includes performing, by the UE, at least one of transmission or reception operation with the first network and the second network simultaneously without encountering the band conflict between the first network and the second network.

In an embodiment, the method to determine an occurrence of the band conflict or removal of the band conflict for MUSIM operation includes determining by the UE, a potential happening of change in performance of the UE based on at least one measurement report, interference level, block error rate, and a quality of service. The change in performance comprises a degradation in the performance of the UE or improvement in the performance of the UE. Moreover, the method includes determining, by the UE, a change occurred in performance of the UE based on at least one measurement report, interference level, block error rate, and a quality of service, wherein the change is performance comprises a degradation in the performance of the UE or an improvement in the performance of the UE. Furthermore, the method includes determining, an occurrence of the band conflict or removal of the band conflict when a change in performance is determined.

In an embodiment, the UE assistance information message comprises MUSIM assistance information.

In an embodiment, the MUSIM assistance informationcomprises at least one of a temporary capability restriction for a list of band or band combination list or removal of capability restriction for a list of bands or band combination list that are associated with selected network, a preference of configuration or reconfiguration, handover, redirection, release of a serving cell, release of a Secondary Serving Cell (SCell) or Secondary Cell Group (SCG), activation of SCell or SCG, deactivation of SCell or SCG and a reason for occurrence of the band conflict.

In an embodiment, the method to transmit a MUSIM assistance information to the selected network associated with the UE to indicate the occurrence of the band conflict or removal of the band includes receiving, by the UE, a OtherConfig (other configuration) information element (IE) in the RRC reconfiguration message that provides an indication for the transmission of the MUSIM assistance information. The OtherConfig comprises at least one of MUSIM capability restriction configuration, a prohibit timer, a candidate band list or band combination list, an explicit or implicit indication for allowing band conflict reporting, and a reason for initiating the band conflict reporting. Further, the method includes transmitting, by the UE, a MUSIM assistance information to the selected network associated with the UE to indicate the occurrence of the band conflict or the removal of a band conflict based on the candidate band list or band combination list provided in the OtherConfig message and when the prohibit timer is not running. Furthermore, the method includes starting, by the UE, the prohibit timer upon initiation of transmission of the MUSIM assistance information (for example, in the UE Assistance information message).

In an embodiment, the prohibit timer is at least one of not included in the RRC reconfiguration message to allow for immediate reporting of the occurrence of the band conflict or removal of the band conflict or included in the RRC reconfiguration message to restrict the frequent reporting of the occurrence of the band conflict or removal of the band conflict.

In an embodiment, the temporary capability restriction for the band list or band combination list comprises at least one of an avoided band list or avoided band combination list, and at least one of affected band list or affected band combination list including restricted MUSIM capability, wherein each element of the band list or band combination list is represented by an index to the corresponding band or band combination in the candidate band list or band combinations list configured in the OtherConfig.

In an embodiment, the method includes determining, by the UE, while the UE is configured to provide MUSIM assistance information for temporary capability restriction, one of whether the UE has temporary capability restriction for the band conflict or removal of band conflict and the UE did not transmit a UE assistance information message with since UE is configured to provide MUSIM assistance information for temporary capability restriction; or whether at least one of current avoided band list or avoided band combination list and at least one of current affected band list or affected band combination list is different from the one indicated in the last transmission of a UE assistance information message to provide MUSIM assistance information and prohibit timer is not running. Further, the method includes transmitting, by the UE, MUSIM assistance information comprising the avoided band list or avoided band combination list and affected band list or affected band combination list. Also, the method includes starting, by the UE, the prohibit timer upon the initiation of the transmission of the UE assistance information message to provide the MUSIM assistance information.

In an embodiment, the method includes receiving, by the UE, an indication for support of temporary capability restriction reporting comprising of MUSIM band conflict in at least one System Information Block (SIB) from a first network or second network. Further, the method includes transmitting, by the UE, an indication to the occurrence of the temporary capability restriction in at least one of RRC resume complete message or RRC setup complete message during the establishment of connection with at least one of a first network and second network. The indication provided is a single bit value.

In an embodiment, the method includes releasing the MUSIM capability restriction configuration and stopping the prohibit timer, during the connection reestablishment of the UE with at least one of the first network or second network.

In an embodiment, the method includes releasing the MUSIM capability restriction configuration from the UE Inactive Access Stratum (AS) context, if stored and stopping the prohibit timer, while resuming the RRC connection of the RRC Inactive UE with at least one of the first network and second network.

Accordingly, the embodiment herein is to provide a method for handling a Multiple Universal Subscriber Identity Module (MUSIM) the band conflict by a first network or second network associated with UE in a telecommunication networks. The method includes, transmitting, by a first network or second network, a OtherConfig message in RRC reconfiguration message that provides an indication for the transmission of the MUSIM assistance information. The OtherConfig message comprises at least one of MUSIM capability restriction configuration, a prohibit timer, candidate band list or band combination list, an explicit or implicit indication for allowing band conflict reporting, and a reason for initiating the band conflict reporting. Further, the method includes receiving, by the selected network, a signaling message indicating the occurrence of the band conflict or removal of the band conflict. The signaling message comprises at least one of a UE assistance information message, UE capability message, RRC resume request message, RRC resume complete message, RRC connection request message and a RRC setup complete message. Thereafter, the method includes transmitting, by the selected network, a RRC reconfiguration message. The RRC reconfiguration message comprises a setup or removal or modification for a band list or a band combination list that resolves the band conflict or removes the band conflict. Furthermore, the method includes performing, by the first network or second network, at least one of transmission or reception operation with the UE simultaneously without encountering the band conflict between the first network and the second network.

In an embodiment, the UE assistance information message includes MUSIM assistance information.

In an embodiment, the MUSIM assistance information comprises at least one of a temporary capability restriction for band list or band combination list or removal of capability restriction for list of bands or band combination list that are associated with selected network, a preference of configuration or reconfiguration, handover, redirection, release of a serving cell, release of a SCell or SCG, activation of SCell or SCG, deactivation of SCell or SCG and a reason for occurrence of the band conflict.

In an embodiment, the method to receive the MUSIM assistance information from the UE to indicate the occurrence of the band conflict or removal of the band includes transmitting, by a first network or second network, a OtherConfig information element (IE) in the RRC reconfiguration message that provides an indication for the transmission of the MUSIM assistance information. The OtherConfig comprises at least one of MUSIM capability restriction configuration, a prohibit timer, candidate band list or band combination list, an explicit or implicit indication for allowing band conflict reporting, and a reason for initiating the band conflict reporting. Further, the method includes receiving, by the selected network, the MUSIM assistance information from the UE to indicate the occurrence of the band conflict or removal of the band based on the OtherConfig message and when the prohibit timer is not running.

In an embodiment, the prohibit timer is at least one of not included in the RRC reconfiguration message to allow for immediate reporting of the occurrence of the band conflict or removal of the band conflict or included in the RRC reconfiguration message to restrict the frequent reporting of the occurrence of the band conflict or removal of the band conflict.

In an embodiment, the method includes transmitting, by the first network or second network, an indication for support of temporary capability restriction reporting comprising of MUSIM band conflict in at least one System Information Block (SIB). Further, the method includes receiving, by the first network or second network, an indication to the occurrence of the MUSIM assistance information in at least one of RRC resume complete message or RRC setup complete message during establishment of connection with the UE, wherein the indication is provided in a single bit value.

Accordingly, the embodiment herein is to provide a User Equipment (UE) for handling a Multiple Universal Subscriber Identity Module (MUSIM) band conflict by a UE in a telecommunication network. The UE comprises a processor and a communication management controller coupled to the processor. The communication management controller is configured to determine an occurrence of a band conflict or removal of a band conflict between a first network and a second network associated with the UE. Further, the communication management controller is configured to select a first network or a second network for the transmission of a MUSIM assistance information based on network characteristics. The network characteristics comprise at least one of capability to support NR, capablility to support carrier aggregation (e.g., Secondary serving Cells, SCells), dual connectivity (e.g. Secondary Cell Group, SCG), being determined as a victim network for the band conflict, and being a network impacted due to the band conflict. Thereafter, the communication management controller is configured transmit a signalling message to the selected network to indicate the occurrence of the of the band conflict or removal of the band conflict, wherein the signalling message comprises at least one of a UE assistance information message, UE capability message, RRC resume request message, RRC resume complete message, RRC connection request message and a RRC setup complete message. Furthermore, the communication management controller is configured to receive a RRC Reconfiguration message from the network apparatus. The RRC reconfiguration message comprises a setup or removal or modification for a band list or a band combination list. Moreover, the communication management controller is configured to perform at least one of transmission or reception operation with the first network and the second network simultaneously without encountering the band conflict between the first network and the second network.

Accordingly, the embodiment herein is to provide a first network or a second network for handling a Multiple Universal Subscriber Identity Module (MUSIM) the band conflict by a first network or second network associated with UE in a telecommunication network. The first network or second network comprises a processor and a communication management controller coupled to the processor. The communication management controller is configured to transmit a OtherConfig message in RRC reconfiguration message that provides an indication for the transmission of the MUSIM assistance information, wherein the OtherConfig message comprises at least one of MUSIM capability restriction configuration, a prohibit timer, candidate band list or band combination list, an explicit or implicit indication for allowing band conflict reporting, and a reason for initiating the band conflict reporting. Further, the communication management controller is configured to receive a signaling message indicating the occurrence of the band conflict or removal of the band conflict. The signaling message comprises at least one of a UE assistance information message, UE capability message, RRC resume request message, RRC resume complete message, RRC connection request message and a RRC setup complete message. Further, the communication management controller is configured to transmit a RRC reconfiguration message. The RRC reconfiguration message comprises a setup or removal or modification for a band list or a band combination list that resolves the band conflict or removes the band conflict. Furthermore, the communication management controller is configured to perform at least one of transmission or reception operation with the UE simultaneously without encountering the band conflict between the first network and the second network.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for method and network for utilizing phase continuity for generating waveforms with low peak-to average power ratio.

### BRIEF DESCRIPTION OF DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 illustrates a system architecture for handling MUSIM band conflict in telecommunication network, according to the embodiment as disclosed herein;

FIG. 2A is a block diagram that illustrates a UE for handling MUSIM band conflict in the telecommunication network, according to the embodiment as disclosed herein;

FIG. 2B is a block diagram that illustrates a network apparatus for handling MUSIM band conflict in a telecommunication network, according to the embodiment as disclosed herein;

FIG. 3 is a flow diagram that illustrates a method of for handling MUSIM band conflict at UE in the telecommunication network, according to the embodiment as disclosed herein;

FIG. 4 is a flow diagram that illustrates a method of for handling MUSIM band conflict at network side in the telecommunication network, according to the embodiment as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

MUSIM devices host more than one Subscriber Identity Module (SIM) to facilitate connection with two or more different Networks (NWs). For example, the MUSIM devices can avail different data plans for different user profiles like home and office. Also, the MUSIM device increases connectivity/reliability with multiple connections. One or more of the multiple SIMs may be engaged in paging reception, System Information Block (SIB) acquisition, measurements, data or voice call, Multicast and Broadcast Service (MBS) reception, emergency call, Access Stratum (AS) signaling, Non-Access Stratum (NAS) signaling and so on. Some of these operations are periodic like paging, measurements and some are aperiodic and/or un-deterministic like signaling. Further, the duration that is required to complete the operation may also be fixed or unpredictable.

There are different types of MUSIM devices like Single Rx-Single Tx, Dual Rx-Single Tx, Dual Tx-Single Rx, Dual Rx-Dual Tx and Multi Rx-Multi Tx depending upon the number of Rx (Reception) chain and Tx (Transmission) chain. The Rx or Tx chain includes the RF circuitries and associated hardware and software components for reception and transmission respectively. The Dual Rx-Dual Tx device can normally support simultaneous Radio Resource Control (RRC) connections on its multiple subscriptions. These devices are also sometimes called Dual Stack-Dual Active (DSDA) devices. It may be also possible for Single Rx-Single Tx, Dual Rx-Single Tx, Dual TxSingle Rx devices to support multiple simultaneous RRC connections through some methods for sharing their Rx and Tx chain and switching based on need.

A potential issue with MUSIM devices is the band conflict when one or more SIMs are operated. For example, when 2 SIMs operate together, the band conflict issue could arise due to many causes. One cause can be that the bands used by the first SIM are harmonics (multiple) of the bands used by the second SIM and this causes the interference e.g. during the reception on the first SIM. Another cause can be a high interference perceived on the reception occasions of the first SIM when there are concurrent transmissions on the second SIM. Another cause could be that the UE implementations are designed to share Radio Frequency (RF) hardware components across the bands used by the two SIMs that restricts the usage or degrades the performance when the two SIMs are operated together for these bands. The two SIMs can encounter the band conflict issue in the RRC_CONNECTED-RRC_CONNECTED or RRC_IDLE/RRC_INACTIVE-RRC_CONNECTED or RRC_CONNECTEDRRC_IDLE/RRC_INACTIVE or RRC_IDLE/RRC_INACTIVE-RRC_IDLE/RRC_INACTIVE states.

Thus, it is desired to address the above-mentioned disadvantages or other shortcomings or at least provide a useful alternative to overcome the band conflict issue in MUSIM devices.

In one aspect, the objectives are achieved by providing a method for handling a Multiple Universal Subscriber Identity Module (MUSIM) band conflict by a UE in a telecommunication network. The method includes determining, by a User Equipment (UE), an occurrence of a band conflict or removal of a band conflict for MUSIM operation between a first network and a second network associated with the UE. Further, the method includes selecting, by the UE, a first network or a second network for the transmission of a MUSIM assistance information based on network characteristics. The network characteristics comprise at least one of capability to support 5G New Radio (NR), capablility to support carrier aggregation, or dual connectivity, being determined as a victim network for the band conflict, and being a network impacted due to the band conflict. Thereafter, the method includes transmitting, by the UE, a signalling message to the selected network to indicate the occurrence of the band conflict or removal of the band conflict. The signalling message comprises at least one of a UE assistance information message, UE capability message, RRC resume request message, RRC resume complete message, RRC connection request message and a RRC setup complete message. Furthermore, the method includes receiving, by the UE, a RRC reconfiguration message from the network apparatus. The RRC reconfiguration message comprises a setup or removal or modification for a band list or a band combination list that resolves the band conflict or removes the band conflict. Further, the method includes performing, by the UE, at least one of transmission or reception operation with the first network and the second network simultaneously without encountering the band conflict between the first network and the second network.

In an embodiment, the method to determine an occurrence of the band conflict or removal of the band conflict for MUSIM operation includes determining by the UE, a potential happening of change in performance of the UE based on at least one measurement report, interference level, block error rate, and a quality of service. The change in performance comprises a degradation in the performance of the UE or improvement in the performance of the UE. Moreover, the method includes determining, by the UE, a change occurred in performance of the UE based on at least one measurement report, interference level, block error rate, and a quality of service, wherein the change is performance comprises a degradation in the performance of the UE or an improvement in the performance of the UE. Furthermore, the method includes determining, an occurrence of the band conflict or removal of the band conflict when a change in performance is determined.

In an embodiment, the UE assistance information message comprises MUSIM assistance information.

In an embodiment, the MUSIM assistance informationcomprises at least one of a temporary capability restriction for a list of band or band combination list or removal of capability restriction for a list of bands or band combination list that are associated with selected network, a preference of configuration or reconfiguration, handover, redirection, release of a serving cell, release of a Secondary Serving Cell (SCell) or Secondary Cell Group (SCG), activation of SCell or SCG, deactivation of SCell or SCG and a reason for occurrence of the band conflict.

In an embodiment, the method to transmit a MUSIM assistance information to the selected network associated with the UE to indicate the occurrence of the band conflict or removal of the band includes receiving, by the UE, a OtherConfig (other configuration) information element (IE) in the RRC reconfiguration message that provides an indication for the transmission of the MUSIM assistance information. The OtherConfig comprises at least one of MUSIM capability restriction configuration, a prohibit timer, a candidate band list or band combination list, an explicit or implicit indication for allowing band conflict reporting, and a reason for initiating the band conflict reporting. Further, the method includes transmitting, by the UE, a MUSIM assistance information to the selected network associated with the UE to indicate the occurrence of the band conflict or the removal of a band conflict based on the candidate band list or band combination list provided in the OtherConfig message and when the prohibit timer is not running. Furthermore, the method includes starting, by the UE, the prohibit timer upon initiation of transmission of the MUSIM assistance information (for example, in the UE Assistance information message).

In an embodiment, the prohibit timer is at least one of not included in the RRC reconfiguration message to allow for immediate reporting of the occurrence of the band conflict or removal of the band conflict or included in the RRC reconfiguration message to restrict the frequent reporting of the occurrence of the band conflict or removal of the band conflict.

In an embodiment, the temporary capability restriction for the band list or band combination list comprises at least one of an avoided band list or avoided band combination list, and at least one of affected band list or affected band combination list including restricted MUSIM capability, wherein each element of the band list or band combination list is represented by an index to the corresponding band or band combination in the candidate band list or band combinations list configured in the OtherConfig.

In an embodiment, the method includes determining, by the UE, while the UE is configured to provide MUSIM assistance information for temporary capability restriction, one of whether the UE has temporary capability restriction for the band conflict or removal of band conflict and the UE did not transmit a UE assistance information message with since UE is configured to provide MUSIM assistance information for temporary capability restriction; or whether at least one of current avoided band list or avoided band combination list and at least one of current affected band list or affected band combination list is different from the one indicated in the last transmission of a UE assistance information message to provide MUSIM assistance information and prohibit timer is not running. Further, the method includes transmitting, by the UE, MUSIM assistance information comprising the avoided band list or avoided band combination list and affected band list or affected band combination list. Also, the method includes starting, by the UE, the prohibit timer upon the initiation of the transmission of the UE assistance information message to provide the MUSIM assistance information.

In an embodiment, the method includes receiving, by the UE, an indication for support of temporary capability restriction reporting comprising of MUSIM band conflict in at least one System Information Block (SIB) from a first network or second network. Further, the method includes transmitting, by the UE, an indication to the occurrence of the temporary capability restriction in at least one of RRC resume complete message or RRC setup complete message during the establishment of connection with at least one of a first network and second network. The indication provided is a single bit value.

In an embodiment, the method includes releasing the MUSIM capability restriction configuration and stopping the prohibit timer, during the connection reestablishment of the UE with at least one of the first network or second network.

In an embodiment, the method includes releasing the MUSIM capability restriction configuration from the UE Inactive Access Stratum (AS) context, if stored and stopping the prohibit timer, while resuming the RRC connection of the RRC Inactive UE with at least one of the first network and second network.

Accordingly, the embodiment herein is to provide a method for handling a Multiple Universal Subscriber Identity Module (MUSIM) the band conflict by a first network or second network associated with UE in a telecommunication networks. The method includes, transmitting, by a first network or second network, a OtherConfig message in RRC reconfiguration message that provides an indication for the transmission of the MUSIM assistance information. The OtherConfig message comprises at least one of MUSIM capability restriction configuration, a prohibit timer, candidate band list or band combination list, an explicit or implicit indication for allowing band conflict reporting, and a reason for initiating the band conflict reporting. Further, the method includes receiving, by the selected network, a signaling message indicating the occurrence of the band conflict or removal of the band conflict. The signaling message comprises at least one of a UE assistance information message, UE capability message, RRC resume request message, RRC resume complete message, RRC connection request message and a RRC setup complete message. Thereafter, the method includes transmitting, by the selected network, a RRC reconfiguration message. The RRC reconfiguration message comprises a setup or removal or modification for a band list or a band combination list that resolves the band conflict or removes the band conflict. Furthermore, the method includes performing, by the first network or second network, at least one of transmission or reception operation with the UE simultaneously without encountering the band conflict between the first network and the second network.

In an embodiment, the UE assistance information message includes MUSIM assistance information.

In an embodiment, the MUSIM assistance information comprises at least one of a temporary capability restriction for band list or band combination list or removal of capability restriction for list of bands or band combination list that are associated with selected network, a preference of configuration or reconfiguration, handover, redirection, release of a serving cell, release of a SCell or SCG, activation of SCell or SCG, deactivation of SCell or SCG and a reason for occurrence of the band conflict.

In an embodiment, the method to receive the MUSIM assistance information from the UE to indicate the occurrence of the band conflict or removal of the band includes transmitting, by a first network or second network, a OtherConfig information element (IE) in the RRC reconfiguration message that provides an indication for the transmission of the MUSIM assistance information. The OtherConfig comprises at least one of MUSIM capability restriction configuration, a prohibit timer, candidate band list or band combination list, an explicit or implicit indication for allowing band conflict reporting, and a reason for initiating the band conflict reporting. Further, the method includes receiving, by the selected network, the MUSIM assistance information from the UE to indicate the occurrence of the band conflict or removal of the band based on the OtherConfig message and when the prohibit timer is not running.

In an embodiment, the prohibit timer is at least one of not included in the RRC reconfiguration message to allow for immediate reporting of the occurrence of the band conflict or removal of the band conflict or included in the RRC reconfiguration message to restrict the frequent reporting of the occurrence of the band conflict or removal of the band conflict.

In an embodiment, the method includes transmitting, by the first network or second network, an indication for support of temporary capability restriction reporting comprising of MUSIM band conflict in at least one System Information Block (SIB). Further, the method includes receiving, by the first network or second network, an indication to the occurrence of the MUSIM assistance information in at least one of RRC resume complete message or RRC setup complete message during establishment of connection with the UE, wherein the indication is provided in a single bit value.

Accordingly, the embodiment herein is to provide a User Equipment (UE) for handling a Multiple Universal Subscriber Identity Module (MUSIM) band conflict by a UE in a telecommunication network. The UE comprises a processor and a communication management controller coupled to the processor. The communication management controller is configured to determine an occurrence of a band conflict or removal of a band conflict between a first network and a second network associated with the UE. Further, the communication management controller is configured to select a first network or a second network for the transmission of a MUSIM assistance information based on network characteristics. The network characteristics comprise at least one of capability to support NR, capablility to support carrier aggregation (e.g., Secondary serving Cells, SCells), dual connectivity (e.g. Secondary Cell Group, SCG), being determined as a victim network for the band conflict, and being a network impacted due to the band conflict. Thereafter, the communication management controller is configured transmit a signalling message to the selected network to indicate the occurrence of the of the band conflict or removal of the band conflict, wherein the signalling message comprises at least one of a UE assistance information message, UE capability message, RRC resume request message, RRC resume complete message, RRC connection request message and a RRC setup complete message. Furthermore, the communication management controller is configured to receive a RRC Reconfiguration message from the network apparatus. The RRC reconfiguration message comprises a setup or removal or modification for a band list or a band combination list. Moreover, the communication management controller is configured to perform at least one of transmission or reception operation with the first network and the second network simultaneously without encountering the band conflict between the first network and the second network.

Accordingly, the embodiment herein is to provide a first network or a second network for handling a Multiple Universal Subscriber Identity Module (MUSIM) the band conflict by a first network or second network associated with UE in a telecommunication network. The first network or second network comprises a processor and a communication management controller coupled to the processor. The communication management controller is configured to transmit a OtherConfig message in RRC reconfiguration message that provides an indication for the transmission of the MUSIM assistance information, wherein the OtherConfig message comprises at least one of MUSIM capability restriction configuration, a prohibit timer, candidate band list or band combination list, an explicit or implicit indication for allowing band conflict reporting, and a reason for initiating the band conflict reporting. Further, the communication management controller is configured to receive a signaling message indicating the occurrence of the band conflict or removal of the band conflict. The signaling message comprises at least one of a UE assistance information message, UE capability message, RRC resume request message, RRC resume complete message, RRC connection request message and a RRC setup complete message. Further, the communication management controller is configured to transmit a RRC reconfiguration message. The RRC reconfiguration message comprises a setup or removal or modification for a band list or a band combination list that resolves the band conflict or removes the band conflict. Furthermore, the communication management controller is configured to perform at least one of transmission or reception operation with the UE simultaneously without encountering the band conflict between the first network and the second network.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, the embodiments disclose a method for handling a MUSIM band conflict by a UE in a telecommunication network. The method includes determining, by a UE, an occurrence of a band conflict or removal of a band conflict between a first network and a second network associated with the UE. Further, the method includes selecting, by the UE, a first network or a second network for the transmission of a MUSIM assistance information based on network characteristics. The network characteristics comprise at least one of capability to support NR, capability to support carrier aggregation, dual connectivity, being determined as victim network for the band conflict, and being a network impacted due to the band conflict. Thereafter, the method includes transmitting, by the UE, a signalling message to the selected network to indicate the occurrence of the of the band conflict or removal of the band conflict. The signalling message comprises at least one of a UE assistance information message, UE capability message, RRC resume request message, RRC resume complete message, RRC connection request message and a RRC setup complete message. Furthermore, the method includes receiving, by the UE, a RRC Reconfiguration message from the network apparatus. The RRC reconfiguration message comprises a setup or removal or modification for a band list or a band combination list that resolves the band conflict or removes the band conflict. Further, the method includes performing, by the UE, at least one of transmission or reception operation with the first network and the second network simultaneously without encountering the band conflict between the first network and the second network.

Accordingly, the embodiments disclose a method for handling a Multiple Universal Subscriber Identity Module (MUSIM) the band conflict by a first network or second network associated with UE in a telecommunication networks. The method includes, transmitting, by a first network or second network, a OtherConfig message in RRC reconfiguration message that provides an indication for the transmission of the MUSIM assistance information. The OtherConfig message comprises at least one of MUSIM capability restriction configuration, a prohibit timer, candidate band list or band combination list, an explicit or implicit indication for allowing band conflict reporting, and a reason for initiating the band conflict reporting. Further, the method includes receiving, by the selected network, a signaling message indicating the occurrence of the band conflict or removal of the band conflict. The signaling message comprises at least one of a UE assistance information message, UE capability message, RRC resume request message, RRC resume complete message, RRC connection request message and a RRC setup complete message. Thereafter, the method includes transmitting, by the selected network, a RRC reconfiguration message. The RRC reconfiguration message comprises a setup or removal or modification for a band list or a band combination list that resolves the band conflict or removes the band conflict. Furthermore, the method includes performing, by the first network or second network, at least one of transmission or reception operation with the UE simultaneously without encountering the band conflict between the first network and the second network.

Accordingly, the embodiments disclose a UE for handling a MUSIM band conflict by a UE in a telecommunication network. The UE comprises a processor and a communication management controller coupled to the processor. The communication management controller is configured to determine an occurrence of a band conflict or removal of a band conflict between a first network and a second network associated with the UE. Further, the communication management controller is configured to select a first network or a second network for the transmission of a MUSIM assistance information based on network characteristics. The network characteristics comprise at least one of capability to support NR, capability to support carrier aggregation, dual connectivity, being determined as victim network for the band conflict, and being a network impacted due to the band conflict. Thereafter, the communication management controller is configured transmit a signalling message to the selected network to indicate the occurrence of the of the band conflict or removal of the band conflict, wherein the signalling message comprises at least one of a UE assistance information message, UE capability message, RRC resume request message, RRC resume complete message, RRC connection request message and a RRC setup complete message. Furthermore, the communication management controller is configured to receive a RRC Reconfiguration message from the network apparatus. The RRC reconfiguration message comprises a setup or removal or modification for a band list or a band combination list that resolves the band conflict or removes the band conflict. Moreover, the communication management controller is configured to perform at least one of transmission or reception operation with the first network and the second network simultaneously without encountering the band conflict between the first network and the second network.

Accordingly, the embodiments disclose a first network or a second network for handling a MUSIM the band conflict by a first network or second network associated with UE in a telecommunication network. The first network or second network comprises a processor and a communication management controller coupled to the processor. The communication management controller is configured to transmit a OtherConfig message in RRC reconfiguration message that provides an indication for the transmission of the MUSIM assistance information, wherein the OtherConfig message comprises at least one of MUSIM capability restriction configuration, a prohibit timer, candidate band list or band combination list, an explicit or implicit indication for allowing band conflict reporting, and a reason for initiating the band conflict reporting. Further, the communication management controller is configured to receive a signaling message indicating the occurrence of the band conflict or removal of the band conflict. The signaling message comprises at least one of a UE assistance information message, UE capability message, RRC resume request message, RRC resume complete message, RRC connection request message and a RRC setup complete message. Further, the communication management controller is configured to transmit a RRC reconfiguration message. The RRC reconfiguration message comprises a setup or removal or modification for a band list or a band combination list that resolves the band conflict or removes the band conflict. Furthermore, the communication management controller is configured to perform at least one of transmission or reception operation with the UE simultaneously without encountering the band conflict between the first network and the second network.

In a current scenario, in MUSIM devices, consider when both SIMs operate together, the frequency bands (also termed as bands) used by first SIM can interact with some frequency bands that can be overlapped with frequency bands used by the second SIM. The overlapping of the bands leads to the band conflict. Also, the bands used by the first SIM are harmonics of the bands used by the second SIM leads to the band conflict. The occurrence of the band conflicts leads to degradation of the signal quality, call dropping, reduced data speeds, poor network performance and the like.

The proposed solution provides a method for configuring the UE to operate in transmission/reception simultaneously without encountering the band conflict. In the proposed solution, the UE indicates the occurrence of the band conflict or the removal of the band conflict to the network through signalling mechanisms. Further, the network associated with the UE can reallocate the alternative bands to avoid the occurrence of the band conflict. Further, the network associated with the UE indicates the timer for the transmission of the indication of the occurrence of the band conflict or the removal of the band conflict.

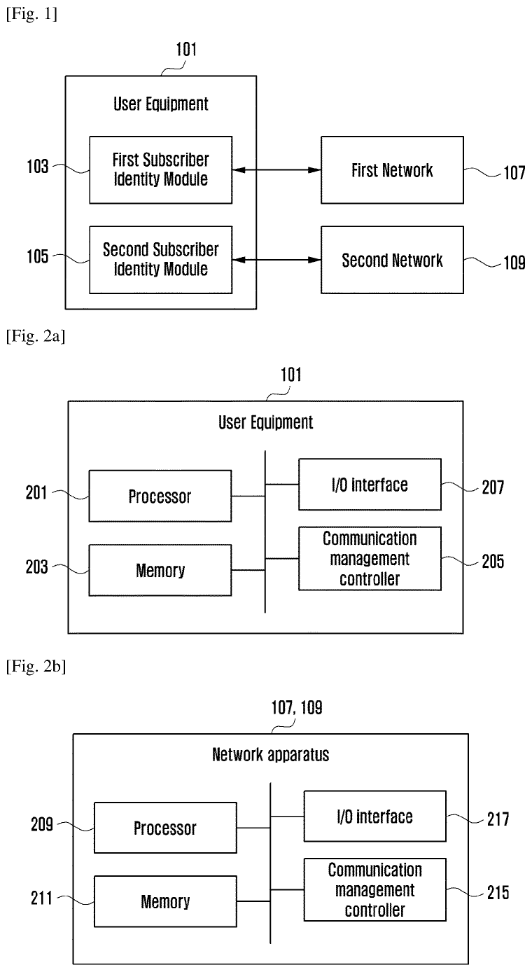

FIG. 1 illustrates a system architecture for handling MUSIM band conflict in telecommunication network, according to the embodiment as disclosed herein. As shown in FIG. 1, the system architecture comprises a User Equipment (101) comprising a first SIM (103) and a second SIM (105), a first network (107) associated with the first SIM (103) and a second network (109) associated with the second SIM (109). The UE (101) can be an end-user device that connects with the first network (107) and second network (109) to access network services. For example, the UE (101) can include, but not limited to a mobile phone, a smart phone, tablets, laptops, television, connected car, and Internet of Things (IoT) devices. The first SIM (103) and the second SIM (105) is a small card that is inserted into the UE (101) to identify and authenticate the user on the mobile network. In some embodiments, the first SIM (103) and the second SIM (109) can be embedded SIM (eSIM) that are integrated into the UE (101) and cannot be physically removable. The first SIM (103) and the second SIM (105) can securely store International Mobile Subscriber Identity (IMSI), a unique identifier associated with the UE (101), and the key used to authenticate and encrypt communication on the first network (107) or second network (109). Each of the first SIM (103) and the second SIM (105) can be associated with the first network (107) and the second network (109) respectively. For example, each of the first SIM (103) and the second SIM (105) can operate with different network operator. In some embodiments, each of the first SIM (103) and the second network (105) can operated with same network operator.

The UE (101) determines the occurrence of the band conflict or removal of the band conflict between the first network (107) and the second network (109) associated with the first SIM (103) and the second SIM (105) of the UE (101). Upon the determination, the UE (101) selects at least one of the first network (107) or the second network (109) for the transmission of MUSIM assistance information. The selection is performed based on the network characteristics of the at least one first network (107) or the second network (109). Further, the UE (101) transmits a signaling message to the selected network to indicate the occurrence of the band conflict or removal of the band conflict. The selected network can be one of the first network (107) or the second network (109). The signaling message can include but not limited to the UE assistance information message, UE capability message, RRC resume request message, RRC resume complete message, RRC connection request message and a RRC setup complete message. Furthermore, the selected network, transmits a RRC reconfiguration message that resolves the band conflict or removes the band conflict based on the received MUSIM assistance information. The RRC reconfiguration message includes at least one of setup or removal or modification for a band list or a band combination list that resolves the band conflict or removes the band conflict. Thereafter, the UE (101) performs the at least one transmission or reception operation with the first network (107) and the second network (109) simultaneously without encountering the band conflict between the first network (107) and the second network (109).

FIG. 2A is a block diagram that illustrates a user equipment for handling MUSIM band conflict in the telecommunication network, according to the embodiment as disclosed herein. The User Equipment (UE) (101) includes a processor (201), a memory (203), an I/O interface (207) and a communication management controller (205). The UE (101) can be an end-user device that connects with a communication network to access services. For example, the UE (101) can include, but not limited to a mobile phone, a smart phone, tablets, laptops, Internet of Things (IoT) devices. The UE (101) comprises of two SIM that includes the first SIM (103) and second SIM (105). Further, the processor (201) of the UE (101) communicates with the memory (203), the I/O interface (207) and the communication management controller (205). The processor (201) is configured to execute instructions stored in the memory (203) and to perform various processes. The processor (201) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU). Further, the memory (203) of the UE (101) includes storage locations to be addressable through the processor (201). The memory (203) is not limited to a volatile memory and/or a non-volatile memory. Further, the memory (203) can include one or more computer-readable storage media. The memory (203) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (203) can store the media streams such as audios stream, video streams, haptic feedbacks and the like. Also, the memory (203) of the UE (101) can store several information received the at least one of the first network (107) and the second network (109). For example, the memory can store several information such as OtherConfig information, RRC reconfiguration information and the like.

The I/O interface (207) transmits the information between the memory (203) and external peripheral devices. The peripheral devices are the input-output devices associated with the UE (101). The I/O interface (207) receives several information from the first network (107) and the second network (109) associated with the first SIM (103) and the second SIM (105) respectively. The several information received from the first network (107) and the second network (109) can include but not limited to the otherconfiguration (otherConfig) information, Radio Resource Control (RRC) reconfiguration information.

The communication management controller (205) communicates with the I/O interface (205) and memory (207) for handling MUSIM band conflict in the telecommunication network. The communication management controller (205) is an innovative hardware that is realized through the physical implementation of both analog and digital circuits, including logic gates, integrated circuits, microprocessors, microcontrollers, memory circuits, passive and active electronic components, as well as optical components. The communication management controller (205) of the UE (101) determines an occurrence of a band conflict or removal of a band conflict between a first network (107) and a second network (109) associated with the UE (101). The communication management controller (205) determines the occurrence of the band conflict or the removal of the band conflict based on the change in the performance of the UE (101). The change in the performance is determined based on at least one of measurement report received from the at least one of the first network (107) or the second network (109), interference level, block error rate, quality of service. Particularly, the occurrence of the band conflict is determined when there is a degradation in the performance of the UE (101). Also, the removal of the band conflict is determined when there is an improvement in the performance of the UE (101). Upon determination, the UE (101) selects at least one of the first network (107) or the second network (109) for the transmission of MUSIM assistance information based on the network characteristics. The network characteristics can include, but not limited to capability to support NR, capability to support carrier aggregation, dual connectivity, being determined as a victim network for the band conflict, and being a network impacted due to the band conflict. Furthermore, the UE (101) transmits a signaling message to the selected network to indicate the occurrence of the band conflict or removal of the band conflict. The selected network can be either the first network (107) or the second network (109). The signaling message can include but not limited to the UE assistance information message, UE capability message, RRC resume request message, RRC resume complete message, RRC connection request message and a RRC setup complete message. The MUSIM assistance information includes at least one of a temporary capability restriction for band list or band combination list or removal of capability restriction for list of bands or band combination list that are associated with selected network, a preference of configuration or reconfiguration, handover, redirection, release of a serving cell, release of a SCell or SCG, activation of SCell or SCG, deactivation of SCell or SCG and a reason for occurrence of the band conflict. Thereafter, the communication management controller (205) receives a RRC Reconfiguration message from the selected network (107/109). The RRC reconfiguration message can include but not limited to a setup or removal or modification for a band list or a band combination list that resolves the band conflict or removes the band conflict. Furthermore, the communication management controller (205) performs transmission or reception with the first network (107) and the second network (109) simultaneously without encountering the band conflict between the first network (107) and the second network (109).

In an embodiment, the UE (101) can determine at least one of a potential conflict issue that can occur or a band conflict that has occurred.

In an embodiment the occurrence in the band conflict is determined by the UE (101), when the first SIM (103) is in RRC_CONNECTED state and the second SIM (105) is transiting from one of RRC_IDLE and RRC_INACTIVE to the RRC_CONNECTED state. During the transition from one of RRC_IDLE and RRC_INACTIVE to the RRC_CONNECTED state or after the transition to the RRC_CONNECTED state, the second SIM (105) can be at least one of configured, receiving, transmitting on downlink and/or uplink band(s) that is conflicting with the downlink and/or uplink band of the first SIM (103). Further, in an alternative description of the scenario, the first SIM (103) and the second SIM (105) can be interchanged or swapped.

In an embodiment, the occurrence of the band conflict is determined by the UE (101), when the first SIM (103) is in one of RRC_IDLE/RRC_INACTIVE/RRC_CONNECTED state and the second SIM (105) is in one of RRC_IDLE and RRC_INACTIVE and performing cell selection/cell reselection. During cell selection/cell reselection, the second SIM (105) may camp to a band that is conflicting with the downlink and/or uplink band of the first SIM (103). Further, in an alternative description of the scenario, the first SIM (103) and the second SIM (105) be interchanged or swapped.

In another embodiment, the occurrence of the band conflict is determined by the UE (101), when the first SIM (103) is in RRC_CONNECTED state and the second SIM (105) is in RRC_CONNECTED state and the second SIM (105) is performing mobility (i.e. handover). The second SIM (105) may be handed over a cell with downlink and/or uplink band that may conflicting with the downlink and/or uplink band of the first SIM (103). Further, in an alternative description of the scenario, the first SIM (103) and the second SIM (105) can be interchanged or swapped.

In yet another embodiment, the occurrence of the band conflict is determined by the UE (101), when the first SIM (103) is in RRC_CONNECTED state and the second SIM (105) is in RRC_CONNECTED state and the second SIM (105) is configured/reconfigured for carrier aggregation configuration or dual-connectivity configuration or a measurement configuration for a frequency/band or is activated for a carrier or a cell. The configuration/reconfiguration or activation operation for the second SIM (105) may involve a downlink and/or uplink band that may conflicting with the downlink and/or uplink band of the first SIM (103). Further, in an alternative description of the scenario, the first SIM (103) and the second SIM (105) be interchanged or swapped.

Also, the UE (101) determines the removal of the band conflict when, the first SIM (103) is in RRC_CONNECTED state and the second SIM (105) is transiting to one of RRC_IDLE and RRC_INACTIVE from the RRC_CONNECTED state. During the transition to one of RRC_IDLE and RRC_INACTIVE from the RRC_CONNECTED state or after the transition to the RRC_IDLE and RRC_INACTIVE state, the second SIM (105) may release the downlink/uplink band(s) and/or stop receiving and/or stop transmitting on downlink and/or uplink band(s) that was conflicting with the downlink and/or uplink band of the first SIM (103). Further, in an alternative description of the scenario, the first SIM (103) and the second SIM (105) be interchanged or swapped.

In an embodiment, the UE (101) determines the removal of the band conflict when, the first SIM (103) is in one of RRC_IDLE/RRC_INACTIVE/RRC_CONNECTED state and the second SIM (105) is in one of RRC_IDLE and RRC_INACTIVE and performing cell selection/cell reselection. During cell selection/cell reselection, the second SIM (105) may camp to a band that is no longer conflicting with the downlink and/or uplink band of the first SIM (103). Further, in an alternative description of the scenario, the first SIM (103) and the second SIM (105) be interchanged or swapped. In another embodiment, the UE (101) determines the removal of the band conflict when, the first SIM (103) is in RRC_CONNECTED state and the second SIM (105) is in RRC_CONNECTED state and the second SIM (105) is performing mobility (i.e. handover). The second SIM (105) may be handed over a cell with downlink and/or uplink band that may no longer be conflicting with the downlink and/or uplink band of the first SIM (103). Further, in an alternative description of the scenario, the first SIM (103) and the second SIM (105) be interchanged or swapped.

In yet another embodiment, the UE (101) determines the removal of the band conflict when, the first SIM (103) is in RRC_CONNECTED state and the second SIM (105) is in RRC_CONNECTED state and the second SIM (105) is configured/reconfigured/released for carrier aggregation configuration or dual-connectivity configuration or a measurement configuration for a frequency/band or is deactivated for a carrier or a cell. The configuration/reconfiguration/release or deactivation operation for the second SIM (105) may involve a removal of downlink and/or uplink band that was conflicting with the downlink and/or uplink band of the first SIM (103). Further, in an alternative description of the scenario, the first SIM (103) and the second SIM (105) be interchanged or swapped.

In some embodiments, the occurrence of the band conflict or removal of the band conflict is determined based on change in the performance of the UE (101). The change in the performance can include one of a degradation of the performance or the improvement in the performance. Particularly, the UE (101) determines the occurrence of the band conflict when there is a degradation in the performance. Similarly, the UE (101) determines the removal of the band conflict when there is an improvement in the performance. The change in the performance can be measured due to decoding of data, measurement of the signal, interference level, block error rate, a quality of service or quality of experience.

In an embodiment, the MUSIM UE triggers a signaling for MUSIM band conflict (or a removal of the band conflict) towards at least one of the networks associated with the respective SIMs when the MUSIM UE determines at least one of a potential happening of one of the earlier-mentioned scenarios, a change in the performance (e.g. decoding of the data, measurement of the signal, interference level, block error rate, a quality of service or a quality of experience).

In an embodiment, the triggers, scenarios and/or thresholds for change in performance for the signaling of the MUSIM band conflict or a removal of the band conflict is at least one of configured by the first network (107) or second network (109), determined by the UE (101) by itself (e.g. through UE implementation) or is specified by the standards.

In an embodiment, the UE (101) triggers the signaling message to at least one of the first network (107) associated with the first SIM (103) and the second network (109) associated with the second SIM (105) to indicate the occurrence of the band conflict or removal of the band conflict. For example, the signaling message can be at least one of a Radio Resource Configuration (RRC) signaling message and Medium Access Control (MAC) signaling message. Further, the signaling message includes at least one of a UE assistance information message, a UE capability message, a RRC Resume request message, a RRC Resume complete message, a RRC connection request message and a RRC setup complete.

In an embodiment, The UE (101) the signaling message (e.g. a UE assistance information message) to the first network (107) associated with the first SIM (103) includes an indication/information for occurrence of band conflict (or a removal of the band conflict) with the second network (109) associated with second SIM (105), can be encoded to carry at least one of the following or a combination of the following:
a) A list of downlink and/or uplink bands or band combinations for one of the first network (107) associated with the first SIM (103) or that are not in conflict. That is, an updated list with removing the bands that are in conflict is composed and sent to the network. For example, the IE NonConflictBandCombinationList contains a list of NR CA, NR non-CA and/or MR-DC band combinations (also including DL only or UL only band) that are not in conflict. It is an exhaustive list. The message structure for the UE assistance information for including the list of nonconflict band combination list is as shown below:

UEAssistanceInformation-v1800-IEs ::= SEQUENCE {
musim-Assistance-r17 MUSIM-Assistance-r17 OPTIONAL,
}
MUSIM-Assistance-r18 ::= SEQUENCE {
musim-BandConflict-r18 NonConflictBandCombinationList
OPTIONAL,
}

b) A list of downlink and/or uplink bands or band combinations for one of the first network (107) associated with the first SIM (103) that are in conflict. The list of bands that are the updated list of bands for indicating the occurrence of the band conflict. For example, the IE ConflictBandCombinationList contains a list of NR CA, NR non-CA and/or MR-DC band combinations (also including DL only or UL only band) that are in conflict for MUSIM. The message structure for the UE assistance information for including the list of conflict band combination list is as shown below:

UEAssistanceInformation-v1800-IEs ::= SEQUENCE {
musim-Assistance-r17 MUSIM-Assistance-r17
OPTIONAL,
}
MUSIM-Assistance-r18 ::= SEQUENCE {
musim-BandConflict-r18 ConflictBandCombinationList
OPTIONAL,
}

c) A list of downlink and/or uplink bands or band combinations for the second network (109) associated with the second SIM (105). That is all the bands or band combinations information for the second SIM (105) is indicated to the network associated with the first SIM (103). For example, the IE OtherSIMBandCombinationList contains a list of NR CA, NR non-CA and/or MR-DC band combinations (also including DL only or UL only band) that are configured for the other SIM. The message structure for the UE assistance information for including the list of all the bands or band combination is as shown below:

UEAssistanceInformation-v1800-IEs ::= SEQUENCE {
musim-Assistance-r17 MUSIM-Assistance-r17
OPTIONAL,
}
MUSIM-Assistance-r18 ::= SEQUENCE {
musim-BandConflict-r18 OtherSIMBandCombinationList OPTIONAL,
}

d) A list of downlink and/or uplink bands or band combinations for the second network (109) associated with the second SIM (105) that are in conflict or potentially may be in conflict with network associated with the first SIM (103).
e) A list of downlink and/or uplink bands or band combinations for the first network (107) associated with the first SIM (103) that are not in conflict, is prepared with respect to the existing or latest UE configuration (e.g. RRC reconfiguration) received by the UE (101) on the first network (107) associated with the first SIM (103). This facilitates a smaller signaling overhead as only delta information needs to be conveyed. For example, the IE ConfNonConflictBandCombinationList contains a list of NR CA, NR non-CA and/or MR-DC band combinations (also including DL only or UL only band) that are not in conflict for MUSIM. The message structure for the UE assistance information for including the list of configurations non conflict band combination list is as shown below:

UEAssistanceInformation-v1800-IEs ::= SEQUENCE {
musim-Assistance-r17 MUSIM-Assistance-r17
OPTIONAL,
}
MUSIM-Assistance-r18 ::= SEQUENCE {
musim-BandConflict-r18
ConfNonConflictBandCombinationList OPTIONAL,
}

f) A list of downlink and/or uplink bands or band combinations for the first network (107) associated with the first SIM (103) that are in conflict, is prepared with respect to the existing or latest UE configuration (e.g. RRC reconfiguration) received by the UE (101) on the first network (107) associated with the first SIM (103). This facilitates a smaller signaling overhead as only delta information needs to be conveyed. The IE ConfConflictBandCombinationList contains a list of NR CA, NR non-CA and/or MRDC band combinations (also including DL only or UL only band) that are configured for the UE in RRC reconfiguration and are in conflict for MUSIM. The message structure for the UE assistance information for including the list of configurations conflict band combination list is as shown below:

```
UEAssistanceInformation-v1800-IEs ::= SEQUENCE {
  musim-Assistance-r17 MUSIM-Assistance-r17
OPTIONAL,
}
  MUSIM-Assistance-r18 ::= SEQUENCE {
musim-BandConflict-r18 ConfConflictBandCombinationList
OPTIONAL,
}
```

g) A list of downlink and/or uplink bands or band combinations for the first network (107) associated with the first SIM (103) that are not in conflict, is prepared with respect to the UE capability information message previously sent by the UE (101) to the first network (107) or with respect to the temporary UE capability for MUSIM previously send by the UE (101) or with respect to the band conflict previously reported by the UE (101).
h) A list of downlink and/or uplink bands or band combinations for the first network (107) associated with the first SIM (103) that are in conflict, is prepared with respect to the UE capability information message previously sent by the UE (101) to the first network (107) or with respect to the temporary UE capability for MUSIM previously send by the UE (101) or with respect to the band conflict previously reported by the UE (101).
i) A list of downlink and/or uplink bands or band combinations for the first network (107) associated with the first SIM (103) that are not in conflict, is prepared with respect to the UE capability information message previously sent by the UE (101) to the first network (107) or with respect to the temporary UE capability for MUSIM previously send by the UE (101) or with respect to the band conflict previously reported by the UE (101).
j) A list of downlink and/or uplink bands or band combinations for the first network (107) associated with the first SIM (103) that are supported by the first SIM (103).

In an embodiment, the earlier-mentioned embodiment for signaling (e.g. a UE assistance information message) of band conflict (or a removal of the band conflict) is applicable with swapping/interchanging the description for the first.

In an embodiment, the UE (101) transmits the signaling message to any one of the first network (107) or second network (109) including at least one of a cause for the occurrence of the band conflict or removal of the band conflict, preference of configuration/reconfiguration, handover, redirection, release, activation, deactivation of for example, CA configuration (i.e. SCells), DC configuration (i.e. SCG), a measurement configuration, a measurement object, a band, a band combination, a carrier, a cell, a connection along with UE assistance information.

In another embodiment, the signaling message can include the list of conflicts for side link bands or band combinations.

In an embodiment, the UE (101) is configured by the at least one of the first network (107) or the second network (109) configure through OtherConfig message for reporting about the occurrence of the band conflict or the removal of the band conflict in the signaling message. Upon the reception of the configuration, the UE (101) can report about the occurrence of the band conflict or removal of the band conflict through the signaling message. The transmission for the configuring the UE (101) for reporting is determined based on UE capability. The UE (101) is determined to be capable of reporting, when it supports MUSIM and also dual transmission and dual reception at the same time. Also, the OtherConfig includes a prohibit timer to restrict the UE (101) from excessive or frequent reporting of occurrence of the band conflict or removal of the band conflict. For example, when the prohibit timer is running, the UE (101) does not perform reporting. Similarly, when the prohibit timer is not running, then the UE (101) will perform reporting of the occurrence of the band conflict or the removal of the band conflict. In an embodiment, the OtherConfig message includes a set of bands or band combinations. Further, if there is a conflict in the band or band combination (i.e. candidate band list or band combinations list) provided in the OtherConfig, the UE (101) will send UE Assistance Information (UAI) for band conflict reporting. In an embodiment, another RRC IE than OtherConfig may be used by the first network (107) or second network (109).

In some embodiments, the first network (107) or the second network (109) does not configure the prohibit timer in the OtherConfig for reporting of occurrence of the band conflict (or a removal of the band conflict). When the prohibit timer is not configured, then the UE (101) immediately reports the occurrence of the band conflict issue (or a removal of the band conflict) as it is encountered or determined to be happening. In another embodiment, the prohibit timer can be configured with a 0 value for the timer to) immediately reports the occurrence of the band conflict issue (or a removal of the band conflict) as it is encountered or determined to be happening.

In an embodiment an example for specification is provided for the configuration related to the reporting of occurrence of the band conflict (or a removal of the band conflict) as follows:

OtherConfig-v1800 ::= SEQUENCE {
musim-BandConflictAssistanceConfig-r18 SetupRelease
{MUSIM-BandConflcitAssistanceConfig-r18} OPTIONAL,
-- Need M
}
MUSIM-AssistanceConfig-r17 ::= SEQUENCE {
musim-BandConflictProhibitTimer-r18 ENUMERATED {s0, s0dot1,
s0dot2, s0dot3, s0dot4, s0dot5, s1, s2, s3, s4, s5, s6, s7, s8, s9, s10}
}

The UE shall:
1> if the received otherConfig includes the musim-BandConflictAssistanceConfig:
   2> if musim-BandConflcitAssistanceConfig is set to setup:
   3>consider itself to be configured to provide MUSIM assistance information for band conflict;
   2> else:
      3>consider itself not to be configured to provide MUSIM assistance information for band conflict and stop timer Txyz (also termed as Prohibit timer), if running;

The UE (101) capable of providing MUSIM assistance information for band conflict may initiate the procedure if it was configured to do so, upon determining it encounters a band conflict or a removal of band conflict, or upon determining that it is about to enter a scenario that causes or removes a band conflict, or upon change in performance due to a band conflict or a removal of band conflict.
1> if UE configured to provide MUSIM assistance information for band conflict
   2> if the UE has a determined a level of degradation in performance or identified a scenario for potential band conflict or a removal of band conflict and the UE did not transmit a UEAssistanceInformation message with musim-BandCombinationList since it was configured to provide MUSIM assistance information for band conflict; or
   2> if the current musim-BandCombinationList is different from the one indicated in the last transmission of the UEAssistanceInformation message including musimBandCombinationList and the timer Txyz (Prohibit timer) is not running:
      3> initiate transmission of the UEAssistanceInformation message to provide the current musim-BandCombinationList;
      3> start or restart the timer Txyz (Prohibit timer) with the timer value set to the musim-BandConflictProhibitTimer.

In an embodiment, upon initiation of RRC connection resume, the UE (101) releases the musim-BandConflictAssistanceConfig from the UE Inactive Access Stratum (AS) context, if stored and stop timer Txyz (Prohibit timer), if running.

In an embodiment, Musim-BandConflictAssistanceConfig may comprise at least one of BandConflcitProhibitTimer, a set of bands or band combinations, an explicit or implicit indication for allowing for band conflict reporting, a trigger/condition/scenario for initiating the band conflict reporting, and any associated parameters for band conflict reporting.

In an embodiment, upon initiation of RRC connection reestablishment, the UE (101) releases the musim-BandConflictAssistanceConfig, if configured and stop timer Txyz (Prohibit timer), if running.

In an embodiment, musim-BandConflictProhibitTimer (also termed as Prohibit timer) is started upon transmitting UE assistance information with MUSIM band conflict information (or removal of MUSIM band conflict).

In an embodiment, musim-BandConflictProhibitTimer is stopped (and/or released) upon releasing musim-BandConflictAssistanceConfig during at least one of the connection re-establishment procedure or resume procedures, or upon receiving musim-BandConflictAssistanceConfig set to release, or upon receiving RRC connection release or RRC connection release with suspendconfig, or upon state transition to RRC_IDLE/RRC_INACTIVE from RRC_CONNECTED, or upon reselecting to a cell or handover to a network node not supporting the MUSIM band conflict reporting.

In an embodiment, the UE (101) indicates the support for MUSIM band conflict reporting in the UE capability information message to the network, so that network can configure and allow UE for the MUSIM band conflict reporting.

In an embodiment, musim-BandConflictAssistanceConfig is comprised within the musim-AssistanceConfig and the embodiments of the invention described for musimBandConflictAssistanceConfig are equally applicable for musim-AssistanceConfig.

In an embodiment, the UE (101) employs at least one of reactive approach and proactive approach to report the MUSIM band conflict (or removal of the MUSIM band conflict). Reactive approach comprises of reporting UE assistance information including MUSIM band conflict information after the UE has encountered the band conflict and needs to correct the situation. The determination may be based upon on a level degradation noticed or upon a moving out of dual-RX/dual-Tx mode. Proactive approach comprises of reporting UE assistance information including MUSIM band conflict information beforehand or just entering into scenario for the band conflict and avoids the potential issue. The determination may be based on a potential possibility or entering into the scenario which may lead to band conflict.

In an embodiment, the UE capability which is conveyed through the UE capability information message is (statically) stored at least one of Radio Access Network (RAN) and Core Network (CN), while the updated capability conveyed through UE assistance information (e.g. including MUSIM band conflict information) is temporarily stored at RAN and is utilized for the band/carrier/cell/measurement object configuration/modification/release/activation/deactivation for the carrier aggregation (e.g. Secondary serving Cells, SCells) and/or dual connectivity (e.g. Secondary Cell Group, SCG) scenarios. During transition from source gNB to a target gNB, the source gNB provides the temporary capability (including MUSIM band conflict information) to the target gNB to suitably configure/reconfigure the UE (101) with consideration to the indicated MUSIM band conflict information. The information can be conveyed in the Handover preparation information RRC message in the HandoverRequest and target gNB allocates resources for the UE and share the Handover Acknowledge message to source gNB and the source gNB provide RRC reconfiguration message to the UE (101) including the configurations to be used for the target gNB.

In an embodiment, it is up to the UE (101) implementation to determine which of the network or RAT associated with one of the SIMs is selected for signaling of UE assistance information for MUSIM band conflict (or removal of band conflict). Further, the UE (101) implementation may consider at least one of the factors for the selection of network that may include network that supports primary SIM, network that supports NR, network that supports carrier aggregation and/or dual connectivity, network that is the victim network for band conflict, network that is impacted due to bad conflict, network selected in a round-robin manner or some pre-configured scheduling pattern, or network selection is random.

In an embodiment, if the one of the networks is New Radio (NR) and other is Long Term Evaluation (LTE), NR network may be selected for signaling of UE assistance information for MUSIM band conflict (or removal of band conflict). In an embodiment, the triggers and scenarios to consider for MUSIM band conflict are left up to UE implementation. That is, upon configured for MUSIM band conflict reporting, the MUSIM UE may trigger a band conflict report when it determines a level of degradation in performance or a potential band conflict scenario.

FIG. 2B is a block diagram that illustrates a network apparatus for handling MUSIM band conflict in a telecommunication network, according to the embodiment as disclosed herein. The network apparatus (107, 109) includes a processor (209), a memory (211), an I/O interface (217) and a communication management controller (215). The network apparatus (107, 109) can be at least one of the first network (107) associated with first SIM (103) of the UE (101) and the second network (109) associated with second SIM (105) of the UE (101). Further, the processor (209) of the network apparatus (107, 109) communicates with the memory (211), the I/O interface (217) and the communication management controller (215). The processor (209) is configured to execute instructions stored in the memory (211) and to perform various processes. The processor (209) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (211) of the network apparatus (107, 109) includes storage locations to be addressable through the processor (209). The memory (211) is not limited to a volatile memory and/or a non-volatile memory. Further, the memory (211) can include one or more computer-readable storage media. The memory (211) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (211) can store the media streams such as audios stream, video streams, haptic feedbacks and the like. The memory (211) can store several information received from the UE (101). Several information received from the UE (101) can include but not limited to the MUSIM assistance information, temporary capability restriction for band list or band combination list or removal of capability restriction for list of bands or band combination list that are associated with selected network, and a preference of configuration or reconfiguration.

The I/O interface (217) transmits the information between the memory (211) and external peripheral devices. The peripheral devices are the input-output devices associated with the network apparatus (107, 109). The I/O interface (217) receives several information from the UE (101). The several information received from the UE (101) can include but not limited to the signaling message that indicates the occurrence of the band conflict or removal of the band conflict.

The communication management controller (215) communicates with the I/O interface (217) and memory (211) for handling MUSIM band conflict in the telecommunication network. The communication management controller (215) is an innovative hardware that is realized through the physical implementation of both analog and digital circuits, including logic gates, integrated circuits, microprocessors, microcontrollers, memory circuits, passive and active electronic components, as well as optical components. The communication management controller (215) of the UE (101) transmits a OtherConfig message in RRC reconfiguration message that provides an indication for the transmission of the MUSIM assistance information. The OtherConfig message comprises at least one of MUSIM capability restriction configuration, a prohibit timer, candidate band list or band combination list, an explicit or implicit indication for allowing band conflict reporting, and a reason for initiating the band conflict reporting. Further, the communication management controller (215) receives a signaling message indicating the occurrence of the band conflict or removal of the band conflict. The signaling message comprises at least one of a UE assistance information message, UE capability message, RRC resume request message, RRC resume complete message, RRC connection request message and a RRC setup complete message. Also, the communication management controller (215) a RRC reconfiguration message. The RRC reconfiguration message comprises a setup or removal or modification for a band list or a band combination list that resolves the band conflict or removes the band conflict. Also, the communication management controller (215) performs at least one of transmission or reception operation with the UE (101) simultaneously without encountering the band conflict between the first network (107) and the second network (109).

In an embodiment, upon receiving a signaling (e.g. a UE assistance information message) of MUSIM band conflict (or a removal of the 20 band conflict) from the UE, the first network (107) or the second network (109) of the respective SIM (103, 105) may take an action that may include at least of configuration/reconfiguration, handover, redirection, release, activation, deactivation (e.g. of a CA configuration, a DC configuration, a measurement configuration, a measurement object, a band, a band combination, a carrier, a cell, a connection) for the UE (101) and indicates to the UE (101) with a RRC reconfiguration message (a setup, modification or a release of a configuration) or RRC release message or a MAC CE (e.g. an activation or deactivation).

In an embodiment, Network indicates the support for temporary capability restriction reporting comprising of MUSIM band conflict in at least one of system information block (SIB) or a RRC signaling message.

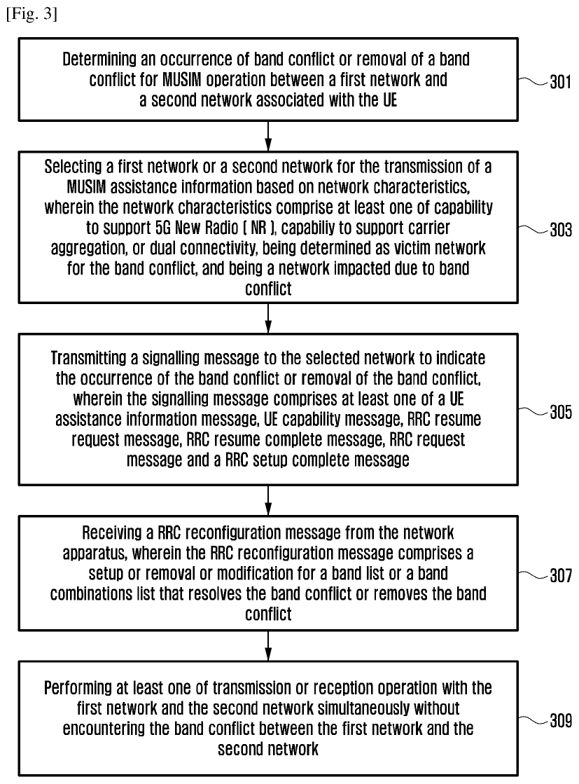

FIG. 3 is a flow diagram illustrating a method of for handling MUSIM band conflict in the telecommunication network, according to the embodiment as disclosed herein.

At block 301, the UE (101) determines an occurrence of the band conflict or removal of the band conflict MUSIM operation between the first network (107) and the second network (109). The occurrence of the band conflict or removal of the band conflict is determined based on the change in the performance of the UE (101). The change in the performance is determined based on at least one measurement report, interference level, block error rate, and a quality of service. Also, the change in the performance can be an improvement of the performance or the degradation of the performance. The occurrence of the band conflict is determined when there is a degradation of the performance of the UE (101). Similarly, the removal of the band conflict is determined when there is an improvement in the performance of the UE (101).

At block 303, the UE (101) selects the first network (107) or the second network (109) for the transmission of the MUSIM assistance information based on the network characteristics. The network characteristics can include but not limited to capability to support 5G New Radio (NR), capability to support carrier aggregation, or dual connectivity, being determined as a victim network for the band conflict, and being a network impacted due to the band conflict.

At block 305, the UE (101) transmits a signalling message to the selected network to indicate the occurrence of the band conflict or removal of the band conflict. The signalling message comprises at least one of a UE assistance information message, UE capability message, RRC resume request message, RRC resume complete message, RRC connection request message and a RRC setup complete message. The UE assistance information message comprises MUSIM assistance information.

At block 307, the UE (101) receives a RRC reconfiguration message from the network apparatus. The RRC reconfiguration message comprises a setup or removal or modification for a band list or a band combination list that resolves the band conflict or removes the band conflict.

At block 309, the UE (101) performs at least one of transmission or reception operation with the first network and the second network simultaneously without encountering the band conflict between the first network and the second network.

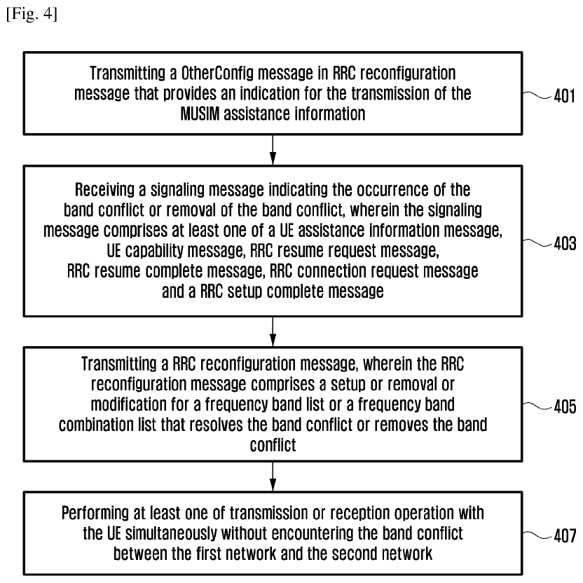

FIG. 4 is a flow diagram illustrating a method of for handling MUSIM band conflict in the telecommunication network, according to the embodiment as disclosed herein.

At block 401, the first network (107) or the second network (109) transmits a OtherConfig message in RRC reconfiguration message that provides an indication for the transmission of the MUSIM assistance information. The OtherConfig message can include but not limited to a MUSIM capability restriction configuration, a prohibit timer, candidate band list or band combination list, an explicit or implicit indication for allowing band conflict reporting, and a reason for initiating the band conflict reporting. The UE (101) transmits the MUSIM assistance information based on the prohibit timer indicated by at least one of the first network (107) or the second network (109). Particularly, when the prohibit time is not included in the OtherConfig message that allows the UE (101) to immediately report about the occurrence of the band conflict or removal of the band conflict. Also, the prohibit timer is included to restrict the frequent reporting of the occurrence of the band conflict or removal of the band conflict.

At block 403, the first network (107) or the second network (109) receives a signaling message indicating the occurrence of the band conflict or removal of the band conflict. The signaling message can include but not limited to a UE assistance information message, UE capability message, RRC resume request message, RRC resume complete message, RRC connection request message and a RRC setup complete message.

At block 405, the first network (107) or the second network (109) transmits the a RRC reconfiguration message. The RRC reconfiguration message comprises a setup or removal or modification for a band list or a band combination list that resolves the band conflict or removes the band conflict.

At block 407, the first network (107) and the second network (109) performs transmission or reception operation with the UE (101) simultaneously without encountering the band conflict.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) supporting a multiple universal subscriber identity module (MUSIM) in a wireless communication system, the method comprising:
receiving, from a first base station associated with a first subscriber identity module (SIM), a radio resource control (RRC) message including other configuration information, wherein the other configuration information includes configuration information on a MUSIM capability restriction;
setting a content for a preference of a temporary capability restriction in a UE assistance information message; and
transmitting, to the first base station, the UE assistance information message including the content.

2. The method of claim 1, setting the content comprising:
in case that the UE has a preference for releasing a secondary cell group (SCG), including first information on the SCG to be release for a MUSIM operation in the UE assistance information message.

3. The method of claim 1, setting the content comprising:
in case that the UE has a preference for indicating a band associated with a restricted capability, including second information on the band associated with the restricted capability for a MUIM operation in the UE assistance information message.

4. The method of claim 1, setting the content comprising:
in case that the UE has a preference for indicating a band to be avoided, including third information on the band to be avoided for a MUSIM operation in the UE assistance information.

5. The method of claim 1,
wherein the preference of the temporary capability restriction is not included in the UE assistance information, in case that the UE has no preference for the temporary capability restriction.

6. The method of claim 1, further comprising:
starting a T346n with a timer value set to a MUSIM prohibit timer, wherein the configuration information on the MUSIM capability restriction further includes at least one a MUSIM candidate band list and the MUSIM prohibit timer.

7. The method of claim 1, further comprising:
receiving, from the first base station, a system information block (SIB) including first indication indicating that the UE is allowed to transmit a second indication, wherein the second indication indicates the temporary capability restriction of the UE due to a MUSIM operation; and
transmitting, to the first base station, the second indication via at least one of a RRC resume complete message or a RRC setup complete message.

8. The method of claim 1,
wherein the UE assistance information message is associated with a second base station with a second SIM.

9. A method performed by a first base station associated with a first subscriber identity module (SIM) supporting a multiple SIM (MUSIM) in a wireless communication system, the method comprising:
transmitting, to a user equipment (UE), a radio resource control (RRC) message including other configuration information, wherein the other configuration information includes configuration information on a MUSIM capability restriction; and
receiving, from the UE, a UE assistance information message including a content for a preference of a temporary capability restriction.

10. The method of claim 9,
wherein in case that the UE has a preference for releasing a secondary cell group (SCG), the UE assistance information message includes first information on the SCG to be release for a MUSIM operation,
wherein in case that the UE has a preference for indicating a band associated with a restricted capability, the UE assistance information message includes second information on the band associated with the restricted capability for a MUIM operation,
wherein in case that the UE has a preference for indicating a band to be avoided, the UE assistance information includes third information on the band to be avoided for a MUSIM operation, and
wherein in case that the UE has no preference for the temporary capability restriction, the preference of the temporary capability restriction is not included in the UE assistance information, and
wherein the UE assistance information message is associated with a second base station with a second SIM.

11. The method of claim 9,
transmitting, to a base station, a system information block (SIB) including first indication indicating that the UE is allowed to transmit a second indication, wherein the second indication indicates the temporary capability restriction of the UE due to a MUSIM operation; and
receiving, from the UE, the second indication via at least one of a RRC resume complete message or a RRC setup complete message.

12. A a user equipment UE supporting a multiple universal subscriber identity module (MUSIM) in a wireless communication system, the UE comprising:
a transceiver; and
a controller configured to:
receive, from a first base station associated with a first subscriber identity module (SIM), a radio resource control (RRC) message including other configuration information, wherein the other configuration information includes configuration information on a MUSIM capability restriction,
set a content for a preference of a temporary capability restriction in a UE assistance information message, and
transmit, to the first base station, the UE assistance information message including the content.

13. The UE of claim 12, wherein the controller is further configured to:
in case that the UE has a preference for releasing a secondary cell group (SCG), include first information on the SCG to be release for a MUSIM operation in the UE assistance information message,
in case that the UE has a preference for indicating a band associated with a restricted capability, including second information on the band associated with the restricted capability for a MUIM operation in the UE assistance information message,
in case that the UE has a preference for indicating a band to be avoided, including third information on the band to be avoided for a MUSIM operation in the UE assistance information,
wherein the preference of the temporary capability restriction is not included in the UE assistance information, in case that the UE has no preference for the temporary capability restriction, and
wherein the UE assistance information message is associated with a second base station with a second SIM.

14. The UE of claim 12, wherein the controller is further configured to:
start a T346n with a timer value set to a MUSIM prohibit timer, wherein the configuration information on the MUSIM capability restriction further includes at least one a MUSIM candidate band list and the MUSIM prohibit timer,
receive, from the first base station, a system information block (SIB) including first indication indicating that the UE is allowed to transmit a second indication, wherein the second indication indicates the temporary capability restriction of the UE due to a MUSIM operation, and
transmit, to the first base station, the second indication via at least one of a RRC resume complete message or a RRC setup complete message.

15. A base station associated with a first subscriber identity module (SIM) supporting a multiple SIM (MUSIM) in a wireless communication system, the first base station comprising:
a transceiver; and
a controller configured to:
transmit, to a user equipment (UE), a radio resource control (RRC) message including other configuration information, wherein the other configuration information includes configuration information on a MUSIM capability restriction, and
receive, from the UE, a UE assistance information message including a content for a preference of a temporary capability restriction.
